(19) United States
(12) Patent Application Publication
(10) Pub. No.: US 2009/0006435 A1
(43) Pub. Date: Jan. 1, 2009

(54) OBJECT IDENTIFIER AWARENESS FOR NETWORK DEVICE NOTIFICATIONS

(75) Inventors: Juan M. Mojica, Cary, NC (US); Walter Dixon, San Jose, CA (US); Richard Gray, Cary, NC (US); Tzu-Ming Tsang, Chapel Hill, NC (US); John Ferguson Linton, Raleigh, NC (US)

Correspondence Address: Stolowitz Ford Cowger LLP, 621 SW Morrison St, Suite 600, Portland, OR, 97205, US

(73) Assignee: Cisco Technology, Inc., San Jose, CA (US)

(21) Appl. No.: 11/778,592

(22) Filed: Jul. 16, 2007

Related U.S. Application Data
(60) Provisional application No. 60/946,938, filed on Jun. 28, 2007.

(51) Int. Cl. G06F 17/30

(52) U.S. Cl. 707/101; 707/E17.009

(57) ABSTRACT

In one embodiment, a control processor sends unique identifiers to each traffic processor in a multi-processor system of different unique identifiers may be sent for each traffic processor supported Management Information Base (MIB). The traffic processors modify MIB object identifiers to include the unique identifiers and then transmit notifications that include the unique identifiers, MIB object identifiers, and associated traffic processor parameter values. In another embodiment, the control processor handles the task of attaching unique identifiers so each MIB object identifiers are uniquely correlated with a particular traffic processor.

### CROSS-REFERENCE TO RELATED APPLICATION

The present application claims priority from U.S. Provisional Patent Application Ser. No. 60/946,938, filed Jun. 28, 2007, incorporated herein by reference in its entirety for all purposes.

### TECHNICAL FIELD

The present disclosure relates generally to the field of networking.

### BACKGROUND

A network device may have multiple traffic processors that process different data for communication links and a control processor that operates as a Simple Network Management Protocol (SNMP) management point. The single SNMP management processor has connectivity with an outside SNMP manager and processes all SNMP requests from outside of the network device.

The control processor may also be responsible for assuring SNMP notifications to the outside SNMP manager correctly identify the processor generating the notification. Otherwise, the SNMP manager cannot identify particular Management Information Bases (MIBs). As far as SNMP is concerned, each MIB has a unique identifier that distinctly identifies an associated processor. However, unique identifiers are not standard across MIBs and each traffic processor have no way of distinguishing associated MIB objects from the MIB objects of other traffic processors.

There currently is no efficient scheme for uniquely identifying which processors in a multi-processor system send SNMP notifications. The SNMP notifications lose relevance and utility in multi-processor system because there is no correlation between the processor that generated the SNMP notification and the notification itself.

### BRIEF DESCRIPTION OF THE DRAWINGS

FIG. 1 is a block diagram showing a multi-processor system that provides unique object identifiers.

FIG. 2 is an alternative embodiment of a multi-processor system that provides unique object identification.

FIG. 3 is a flow diagram describing how a control processor in the systems of FIGS. 1 and 2 may operate.

FIG. 4 shows example SNMP notifications that contain unique object identification.

FIG. 5 is a flow diagram describing how one of the traffic processors of FIGS. 1 and 2 may operate.

FIG. 6 is a block diagram showing an alternative embodiment of how unique identifiers may be associated with object identifiers.

### DESCRIPTION OF EXAMPLE EMBODIMENTS

### Overview

In one embodiment, a control processor sends unique identifiers to each traffic processor in a multi-processor system of different unique identifiers may be sent for each traffic processor supported Management Information Base (MIB). The traffic processors modify MIB object identifiers to include the unique identifiers and then transmit notifications that include the unique identifiers, MIB object identifiers, and associated traffic processor parameter values. In another embodiment, the control processor handles the task of attaching unique identifiers so each MIB object identifiers are uniquely correlated with a particular traffic processor.

### DESCRIPTION

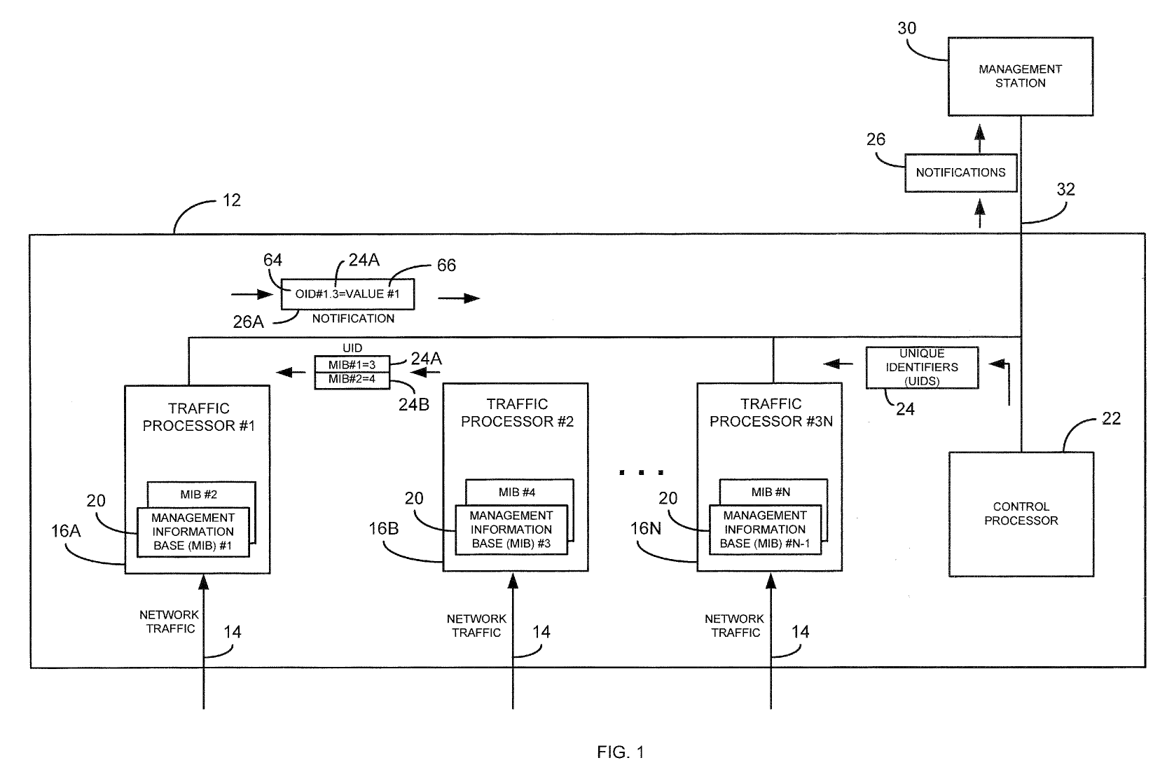

Referring to FIG. 1, a multi-processor network processing device 12 contains multiple traffic processors 16A-16N that process network traffic on communication links 14. Each traffic processor 16 operates one or more Management Information Bases (MIBs) 20. The traffic processors 16 are connected to a control processor 22 that is connected through an external Internet network 32 to a management station 30.

In one embodiment, the network processing device 12 may be a blade in a rack containing multiple network processing devices. The network processing device 12 can be a server, router, switch, gateway, or any other device that processes network traffic from communication links 14. In this embodiment, the network processing device 12 may manage data and voice calls from different cellular, land-line, Digital Subscriber Loop (DSL), cable, Ethernet, etc. communication links 14. The network processing device 12 then routes packets for these different data or voice calls over the Internet network 32.

In another application, traffic processors 16 may be different home computing devices and the control processor 22 may be a router that is connected to the external Internet network 32 through a cable modem. Of course these are only example embodiments, and the unique identifier scheme described below can be used in any application where information needs to be uniquely associated with particular processors.

### Unique Identifiers

Each one of the traffic processors 16 may need to send uniquely identifiable information to a management station 30 in the external network 32. For example, each traffic processor 16 may need to send notifications 26 to the management station 30 whenever certain operating thresholds, operating conditions, or communication link problems are detected. For example, any of the traffic processors 16 may send a notification 26 to management station 30 whenever one of the communication links 14 exceeds a specified bandwidth. Alternatively, the traffic processors 16 may periodically send notifications 26 to the management station 30 that contain different traffic processor statistics. For example, the notifications 26 may identify the number of packets a particular traffic processor 16 received over the last hour.

Unfortunately, the traffic processors 16 may be unaware of other traffic processors in the same network processing device 12. In some systems only a single Internet Protocol (IP) address is associated with all of the multiple processors contained in network device 12. Thus, there is no way to uniquely associate the traffic processors 16 with the information in notifications 26.

In one embodiment, the control processor 22 sends Unique IDentifiers (UIDs) 24 to all of the traffic processors 16 for all supported MIBs 20. For example, control processor 22 may send unique identifiers 24A and 24B to traffic processor 16A for MIBs 20A and 20B, respectively. A UID value of ‘3’ is shown associated with MIB 20A and a UID value of ‘4’ is shown associated with MIB 20B in traffic processor 18 of course, any UID value can be used, The UID values ‘3’ and ‘4’ are uniquely assigned to MIBs #1 and #2, respectively. Other unique UID values 24 are selected and used for other MIBs #3-#N in traffic processors 16B-16N. The UIDs 24 are used by the traffic processors 16 when preparing notifications 26 for sending to management station 30.

The UIDs 24 uniquely associate MIB Object IDentifiers (OIDs) 64 in notifications 26 with a specific traffic processor 16 even though all of the traffic processors 16 are managed through a single control processor 22. For example, the UID 24A uniquely associates the object identifiers for MIB #1 with traffic processor 16A and UID 24B uniquely identifies the object identifiers for MIB #2 with traffic processor 16A.

The traffic processor 16A then modifies the OIDs for MIB #1 to include UID 24A and modifies the OIDs for MIB#2 to include UID 24B. For example, the traffic processor 16A may generate and store a parameter value 64. Parameter value 66 can be any piece of data generated by traffic processor 16A, but in one example is a traffic processor a statistic, such as the percentage of CPU utilization over some time period. The data value 66 is associated with the MIB object identifier (OID) variable 64.

The OID 64 is modified by the traffic processor to include the unique identifier ‘3’. The UID ‘3’, OID 64, and associated data value 66 are all sent in a notification 26A to management station 30. The management station 30 can then use the UID to uniquely associate the information in notification 26A with traffic processor 16A.

FIG. 1 shows one embodiment where the traffic processors 16 send the notifications 26 directly to the management station 30. This embodiment reduces the burden on the control processor 22 by having the traffic processors 16 both generate the notifications 26 and communicate the notifications 26 directly to the management station 30. In this configuration, the control processor 22 only has to send the unique identifiers 24 to traffic processors 16.

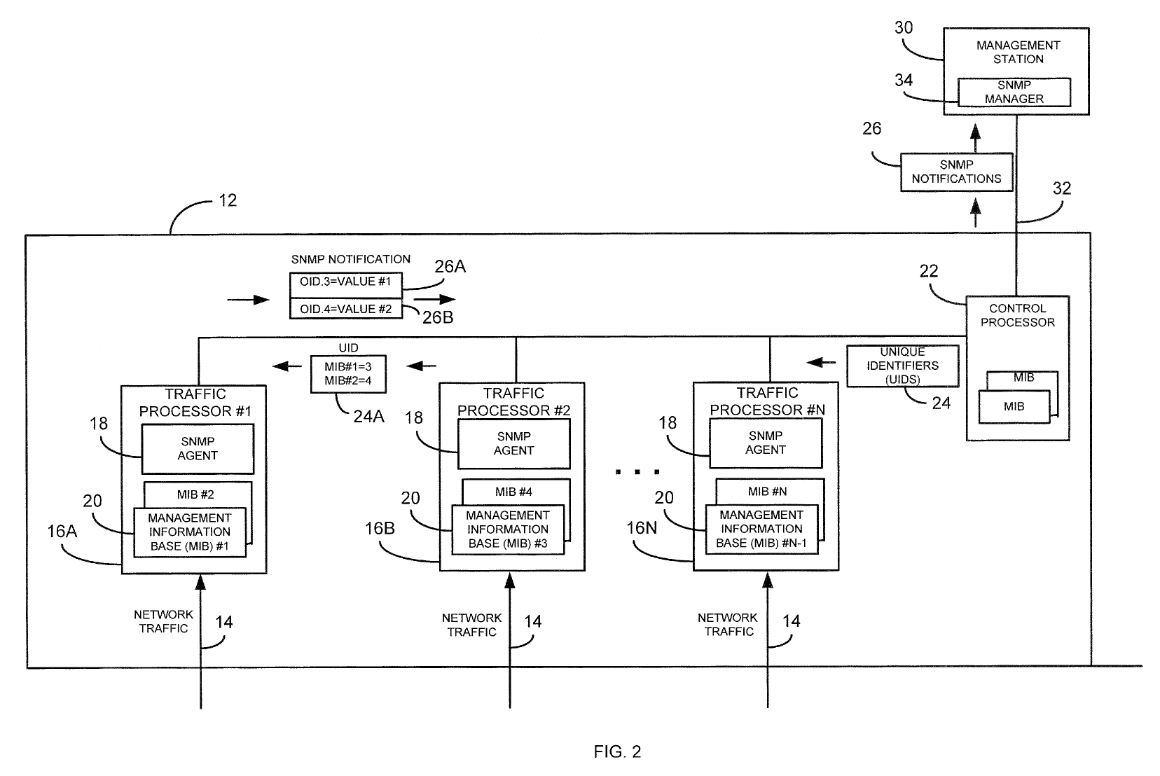

FIG. 2 shows another embodiment where the traffic processors 16 do not communicate directly with the management station 30. The control processor 22 still sends the unique identifiers 24 to the traffic processors 16 as previously shown in FIG. 1. However, the traffic processors 16 send the notifications 26 back to the control processor 22. The control processor 22 then forwards the notifications 26 to the management station 30. This may be necessary when the traffic processors 16 have no direct connectivity with the external Internet network 32.

The traffic processors 16 may encapsulate notifications 26 in a header that is used for inter-processor communications within network processing device 12. The control processor 22 strips off the internal header and then forwards the de-capsulated notification to the management station 30.

In both embodiments shown in FIGS. 1 and 2, more traffic processors 16 can be managed through a single control processor 22 since the traffic processors take over the burden of creating notifications 26. IP address space is also saved since each traffic processor 16 does not require a unique IP address to uniquely identify the information sent to the management station 30. It should also be understood that the UIDs 24 can be used to uniquely associate any type of information with a particular processor 16.

In FIG. 2, the notifications 26 are sent according to a Simple Network Management Protocol (SNMP). In this embodiment, each traffic processor 16 operates a SNMP agent 18 and the management station 30 operates a SNMP manager 34. The SNMP communications may be sent directly from SNMP manager 34 to the SNMP agents 18 in traffic processors 16 or sent via the control processor 22. The SNMP communications may identify what types of SNMP notifications 26 to send and what MIB information to send in the SNMP notifications 26.

When a particular event is detected in one of the traffic processors 16, the SNMP agent 18 in that traffic processor formats the MIB information into a SNMP notification 26 which is then sent to the SNMP manager 34. Similarly to FIG. 1, the MIB object identifiers are modified to include unique identifiers that uniquely associate the SNMP information with an associated traffic processor 16.

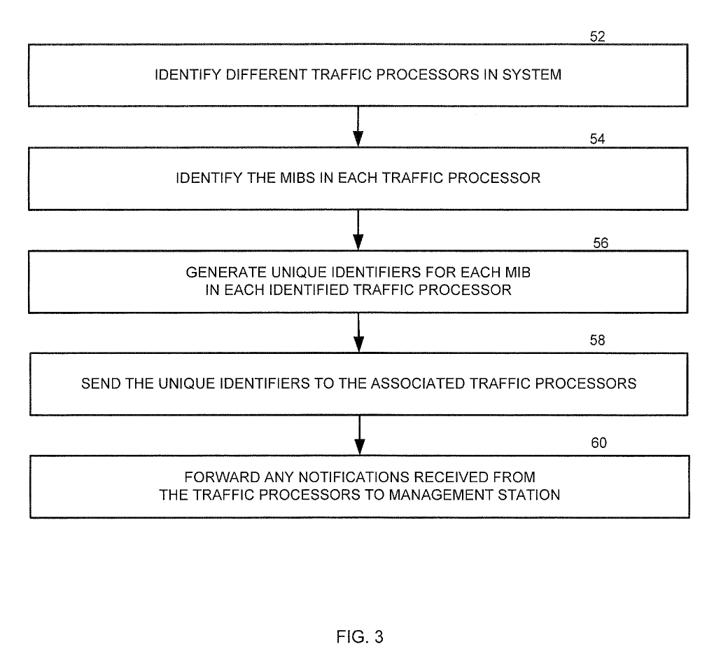

FIG. 3 describes the control processor 22 operations in more detail. In operation 52, the control processor identifies different traffic processors that may be located in the network processor 12. For example, each traffic processor slot in network processing device 12 may be preconfigured with a different value. The control processor in operation 54 then identifies the different MIBs in each traffic processor. The control processor in operation 56 then generates unique identifiers for each MIB in each traffic processor. In the example shown in FIG. 2, the first MIB #1 in traffic processor 16A is assigned UID=3 and the second MIB #2 in traffic processor 16A is assigned UID=4. Other MIBs in other traffic processors are also assigned other unique identifiers.

The UIDs are then sent to the associated traffic processors in operation 58. As described above, the notifications 26 may have to be sent back to the management station 30 (FIGS. 1 and 2) thru the control processor 22. In this case, the control processor forwards the received notifications from the traffic processors to the management station 30 in operation 60. Otherwise, the control processor have no additional involvement with the traffic processor notifications.

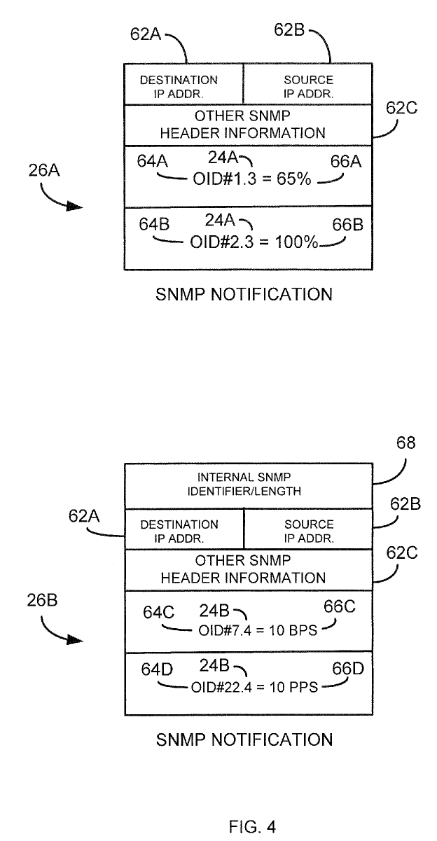

FIG. 4 shows examples of SNMP notifications 26A and 26B in more detail. The notifications 26A and 26B in one embodiment each contain a SNMP header 62 that includes a destination IP address 62A associated with the management station 30 and a source IP address 62B associated with the network processing device 12. The SNMP header 62 may include other conventional SMNP information 62C, such as a SNMP version number.

The object identifier 64A (OID #1) is a MIB variable associated with a particular operating parameter generated by one or the traffic processors. For example, OID#1 may be associated with a CPU utilization value over the last 5 minutes. In the example in FIG. 4, traffic processor 16A had a total CPU utilization value 66A of 65% over the last 5 minutes. The unique identifier 24A is attached to the OID 64A and uniquely associates MIB#1 OID 64A with traffic processor 16A (FIG. 1).

The same SNMP notification 26A may include multiple object identifiers each associated with different parameter values. For example, object identifier 64B (OID#2) identifies the average CPU utilization in traffic processor 16A over the last 5 seconds. In this example, the traffic processor 16A had an average CPU utilization value 66B of 100%. The second object identifier 64B is again modified to include UID 24A to associate the OID 64B with the same MID #1 and traffic processor 16A. The SNMP agent 18 (FIG. 2) in traffic processor 16A may send the SNMP notification 26A to the SNMP manager 34 whenever a particular threshold condition has been detected. For example, the SNMP notification 26A may be sent whenever the CPU utilization in traffic processor 16A exceeds 95%.

Another SNMP notification 26B is built and sent by the same traffic processor 16A for other threshold conditions in traffic processor 16A. In this example, the object identifiers 64C and 64D are still associated with parameters or statistics generated by traffic processor 16A but associated with the second MIB #2. According, the second unique identifier 24B is attached to OIDs 64C and 64D. In this example, the OIDs 64C and 64D are associated with Bits Per Second (BPS) value 66C and a Packets Per Second (PPS) value 66D. But of course, any type of traffic processor information may be sent.

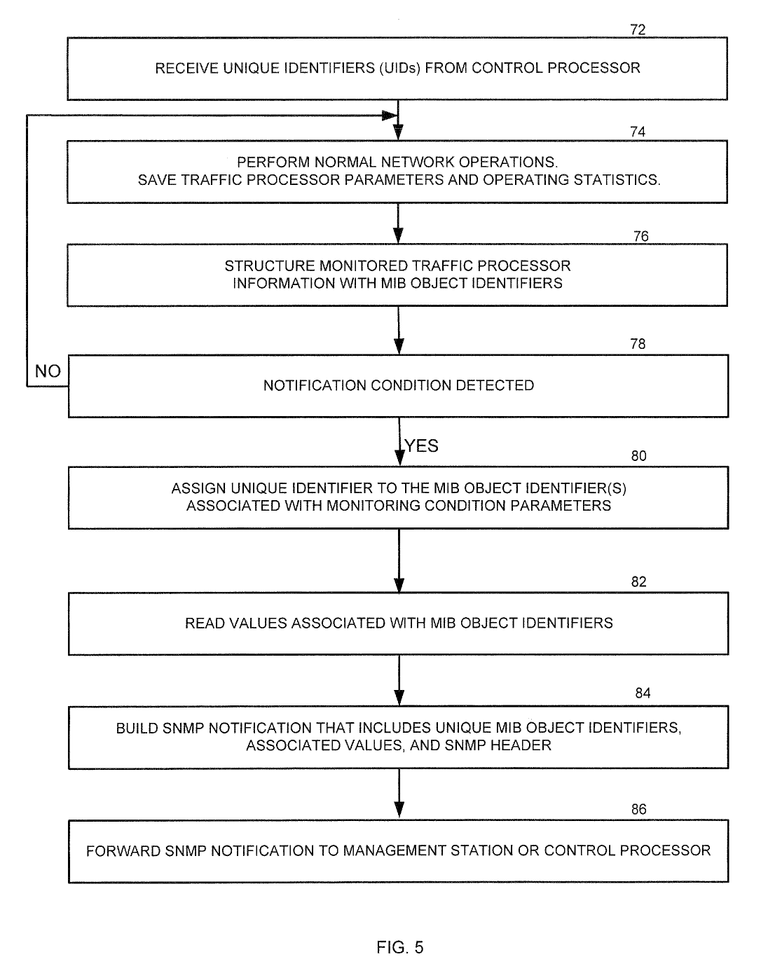

FIG. 5 explains the traffic processor operations in more detail. In operation 72, unique identifiers are received from the control processor for each MIB operated by that traffic processor. There are other configurations where the same UID may be used for multiple MIBs. In this case, the traffic processor may only receive one UID.

In operation 74, the traffic processor performs normal network traffic operations and at the same time derives different traffic processor operating parameters and statistics. For example, as described above, the traffic processor may have been configured to calculate the CPU utilization over different periods of time, such as every 5 seconds and every 5 minutes. Other traffic processor operating parameters may also be monitored, such as, number of dropped packets, packet delay, and other Quality of Service (QoS) or Denial of Service (DoS) information. The traffic processor may also save statistics related to the network traffic itself, such as the amount of packets received, packet sizes, types of packets, and packet source or destination information. Any information needed by the management station 30 for analyzing the operation of the traffic processor may be obtained.

In operation 76, these traffic processor parameters and statistics are structured with MIB object identifiers. For example, the CPU utilization value for the last 5 minutes is assigned a first OID variable 64A as shown in FIG. 4 and the CPU utilization value for the last 5 seconds is assigned the second OID variable 64B as shown in FIG. 4.

The traffic processor obtains the MIB object identifiers for the SNMP notification when a particular notification condition is detected in operation 78. The identified OIDs are then modified to include the unique identifier. The unique identifiers may be combined with the MIB object identifiers either before or after the notification condition is detected in operation 78. The values for the MIB OIDs are read from memory in operation 82. The SMNP notification is built in operation 84 and includes all of the UIDs, OIDs, values, and SNMP header information. The SNMP notification is then either sent to the management station 30 or to the control processor 22 in operation 86.

The SNMP manager 34 in management station 30 (FIG. 2) can determine which traffic processor is associated with a particular UID by performing different SNMP queries. When a SNMP notification 26 is received, the SNMP manager 34 searches local memory for any previously identified UIDs associated with the network processor 12 and associated MIB sending the notification.

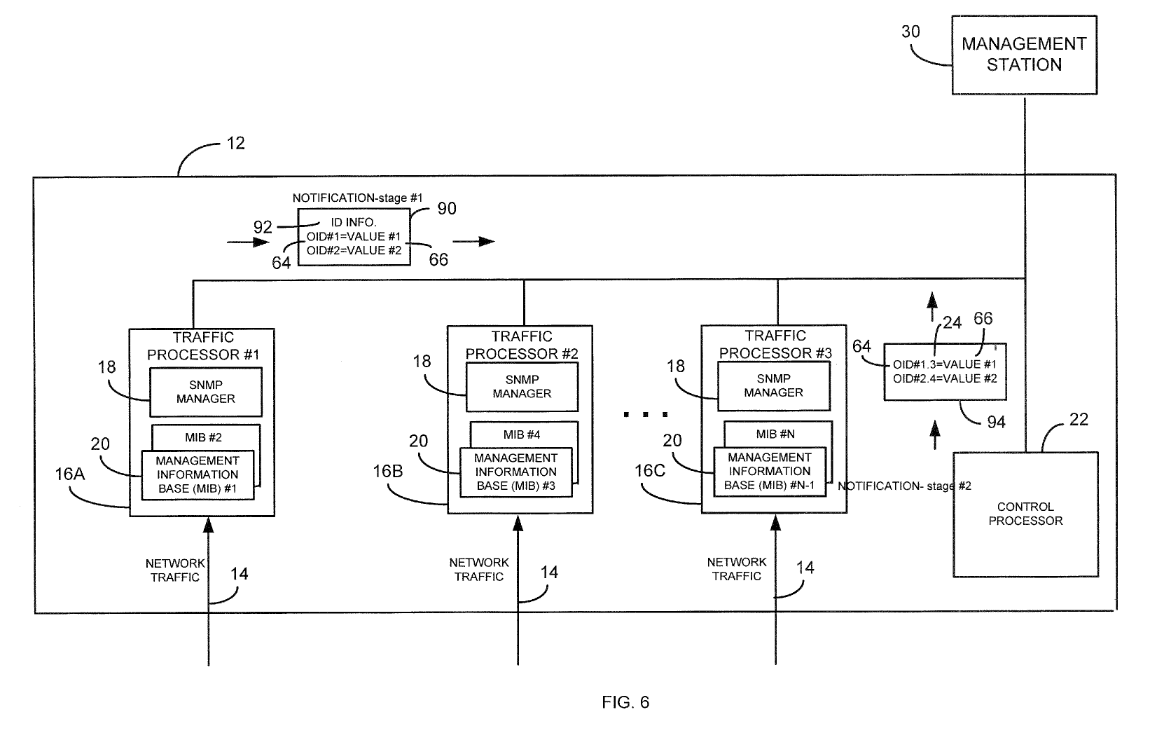

FIG. 6 shows another embodiment where the control processor 22 assigns the unique identifiers to the object identifiers. The control processor in this configuration may not need to send unique identifiers to the individual traffic processors 16. Instead the traffic processors may send notifications 90 to control processor 22 that only include the object identifier variables 64 and associated values 66.

The control processor 22 receives the notification 90 and locates the unique identifiers 24 for the associated traffic processor MIBs. Each traffic processor 16 may send some internal information 92 in notification 90 that allows the control processor 22 to distinguish it from other traffic processors. The control processor 22 determines which traffic processor 16 sent the notification 90 and the type of notification. Based on the type of notification, the control processor 22 determines which OIDs 64 in the notification 90 need to be translated.

The control processor identifies the unique identifier 24 for the traffic processor and MIB associated with the OIDs 64 in notification 90. The OIDs 64 are replaced or modified to include the unique identifier 24. The control processor 22 then sends a modified notification 94 with the translated OID/UID values 64/24 to the management station 30.

Thus, notifications 32 can be associated with specific traffic processors even though multiple traffic processors are managed through a single control processor 22. With this approach, the control processor 22 manipulates the OIDs 64, and no extraneous OID modifications are required by any traffic processors 16. This approach still more devices to be managed through a single control point and also saves IP address space.

Several preferred examples of the present application will now be described with reference to the accompanying drawings. Various other examples of the invention are also possible and practical. This application may be exemplified in many different forms and should not be construed as being limited to the examples set forth herein.

The figures listed above illustrate preferred examples of the application and the operation of such examples. In the figures, the size of the boxes is not intended to represent the size of the various physical components. Where the same element appears in multiple figures, the same reference numeral is used to denote the element in all of the figures where it appears. When two elements operate differently, different reference numerals are used regardless of whether the two elements are the same class of network device.

Only those parts of the various units are shown and described which are necessary to convey an understanding of the examples to those skilled in the art. Those parts and elements not shown are conventional and known in the art.

The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. We claim all modifications and variation coming within the spirit and scope of the following claims.

1. A method comprising:
identifying object identifiers and associated parameter values generated by a processor;
associating a unique identifier with the object identifiers that uniquely identifies the processor that generated the parameter values and distinguishes the processor from other processors in a same system that may also generate object identifiers and associated parameter values; and
sending a notification that contains the unique identifier, object identifiers, and parameter values associated with the object identifiers.

2. The method according to claim 1 further comprising associating different unique identifiers with each different Management Information Base (MIB) operated by the processor.

3. The method according to claim 1 further comprising:
receiving the unique identifier from a control processor;
modifying the object identifiers to include the unique identifiers received from the control processor;
formatting the unique identifier, object identifiers, and parameter values into the notification; and
sending the notification either directly to a management station or sending the notification through the control processor to the management station.

4. The method according to claim 1 further comprising:
receiving a message from a traffic processor that contains the object identifiers and associated parameter values;
identifying the traffic processor that sent the message;
locating the unique identifier associated with the identified traffic processor;
modifying the message to include the located unique identifier associated with the identified traffic processor; and
sending the modified message to a management station as the notification.

5. The method according to claim 1 wherein the notification further comprises a Simple Network Management Protocol (SNMP) notification.

6. The method according to claim 1 wherein the object identifiers further comprise Management Information Base (MIB) object identifier variables.

7. The method according to claim 1 further comprising:
identifying different object identifiers associated with different Management Information Bases (MIBs);
identifying different unique identifiers associated for each of the different MIBs;
modifying the object identifiers to include the unique identifiers associated with the same MIBs; and
sending the notification that includes the modified object identifiers with the different unique identifiers.

8. An apparatus, comprising:
a first processor configured to generate different parameter values and associate the parameter values with different object identifiers; and
the first processor, or a second processor, configured to modify the object identifiers to include unique identifiers that uniquely identify the first processor that generated the parameter values associated with object identifiers.

9. The apparatus according to claim 8 wherein:
the first processor further comprises a traffic processor that is coupled to a communication link and generates parameter values associated with the communication link; and
the second processor further comprises a control processor that sends the unique identifiers to the traffic processor.

10. The apparatus according to claim 9 wherein the traffic processor is further configured to format the unique identifiers, object identifiers, and parameter values associated with the object identifiers into a notification message and then send the notification message to a management station without going through the control processor.

11. The apparatus according to claim 8 wherein:
the first processor further comprises a traffic processor that is coupled to a communication link and generates the parameter values associated with the communication link; and
the second processor further comprises a control processor that receives the object identifiers and associated parameter values from the traffic processor and modifies the received object identifiers to include the unique identifiers associated with traffic processor that generated the parameter values.

12. The apparatus according to claim 8 wherein the first processor also operates a Simple Network Management Protocol (SNMP) agent that formats the parameter values and associated object identifiers into a SNMP notification.

13. The apparatus according to claim 8 wherein the first processor also operates one or more Management Information Bases (MIBs) that generate the object identifiers associated with the parameter values.

14. The apparatus according to claim 13 wherein different unique identifiers are associated with each of the different MIBs.

15. A network processing device, comprising:
multiple traffic processors each operating Management Information Bases (MIBs) that assign object identifiers to different associated traffic processor values; and
a control processor coupled to the multiple traffic processors,
either the multiple traffic processors or the control processor modifying the object identifiers to include device identifiers that identify the traffic processors that generated the traffic processor values.

16. The network processing device according to claim 15 wherein each of the traffic processors operate Simple Network Management Protocol (SNMP) agents that generate SNMP notifications whenever the traffic processors detect a preconfigured operating condition, the SNMP notifications each including the MIB object identifiers, associated traffic processor values, and the device identifiers that identify the traffic processors that generated the traffic processor values.

17. The network processing device according to claim 15 wherein the traffic processors receive the device identifiers from the control processor.

18. The network processing device according to claim 15 wherein the traffic processors send the MIB object identifiers and associated traffic processor values to the control processor and the control processor then assigns the device identifiers to the MIB object identifiers.

19. The network processing device according to claim 15 wherein the traffic processors operate multiple different MIBs and a different device identifier is used with the object identifiers for each of the different MIBs.

20. The network processing device according to claim 15 wherein the traffic processors and control processor are all contained within a same switch or router that switches or routes packets from different network connections over an Internet network and each of the multiple traffic processors in the switch or router independently formats and sends notifications containing the device identifiers, MIB object identifiers, and traffic processor values to a management station in the Internet network.
